(19) United States
(12) Patent Application Publication
(10) Pub. No.: US 2010/0245736 A1
(43) Pub. Date: Sep. 30, 2010

(54) LIGHT DIFFUSION SHEET AND LIQUID CRYSTAL DISPLAY DEVICE

(76) Inventors: Yusuke Nishihara, Osaka (JP); lori Aoyama, Osaka (JP); Tokio Taguchi, Osaka (JP); Akihiro Yamamoto, Osaka (JP); Masumi Kubo, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/681,411

(22) PCT Filed: Sep. 26, 2008
(86) PCT No.: PCT/JP2008/002694

§ 371 Date: Apr. 2, 2010

(30) Foreign Application Priority Data
Oct. 3, 2007 (JP) 2007 259358

(51) Int. Cl. G02F 1/1335

(52) U.S. Cl. 349/112

(57) ABSTRACT

A light diffusing layer 10 included in a light diffusing sheet and a liquid crystal display device of the present invention includes a plurality of low refractive index regions (second regions) 14 formed of a substance which has a low refractive index (second substance). The shape of each of the low refractive index regions in a cross section perpendicular to the major surface is approximated to an isosceles triangle where the base is on the viewer side and the vertex is on the liquid crystal display panel side. The plurality of low refractive index regions are arranged in a high refractive index region (first region) formed of a high refractive index substance (first substance) at a predetermined pitch P in at least one direction in a plane parallel to the major surface. The shape and size of the low refractive index regions satisfy a predetermined relationship, and therefore, light which is perpendicularly incident on the major surface undergoes total reflection only once inside the light diffusing layer before outgoing from the light diffusing layer toward the viewer side, and part of the light which is incident on the major surface at an oblique angle undergoes total reflection n or more times (n is an integer not less than 2) inside the light diffusing layer before outgoing from the light diffusing layer toward the viewer side. As a result, the viewing angle characteristic in the at least one direction is improved.

### TECHNICAL FIELD

The present invention relates to a liquid crystal display device and specifically to a direct-viewing type liquid crystal display device which has a light diffusing layer on the viewer side of a TN mode liquid crystal display panel.

### BACKGROUND ART

Liquid crystal display devices are not self-emitting display devices and, therefore, almost all of them, excluding some reflection-type display devices, require a backside illuminator (so called “backlight unit”) for supplying light for display to the liquid crystal display panel. The backlight units, which are to be provided on the backside of the liquid crystal display panel (opposite to the viewer side), are generally classified into edge light type backlights and direct lighting type backlights. The edge light type is a class of backlights in which light emitted by a light source (CCFT (Cold Cathode Fluorescent Tube) or LED) placed on a side face of a light guide plate is allowed to propagate in the light guide plate and to outgo toward the liquid crystal display panel side. The direct lighting type backlights are configured such that a plurality of light sources are arranged on the back surface of a liquid crystal display panel, and light emitted by the light sources enters the liquid crystal display panel without passing through a light guide plate.

The liquid crystal display devices have a problem that the appearance of display varies depending on the viewing direction, i.e., a problem that the viewing angle characteristics degrade depending on the viewing direction. This results from the fact that the liquid crystal layer has anisotropy in refractive index so that the effective phase difference (retardation) of the liquid crystal layer varies depending on the viewing direction.

One of the known methods for improving the viewing angle characteristics of liquid crystal display devices is controlling the directivity (degree of parallelism) of light from the backlight such that rays which do not adversely affect the viewing angle characteristics are mainly allowed to enter the liquid crystal display panel and omniazimuthally diffusing the rays transmitted through the liquid crystal display panel by means of a microlens or microlens array (e.g., Patent Document 1).

[Patent Document 1] Japanese Laid-Open Patent Publication No. H9-127309

[Patent Document 2] Japanese Laid-Open Patent Publication No. 2003-50307

### DISCLOSURE OF INVENTION

### Problems to be Solved by the Invention

However, when the above-described microlens is used, in any of a microlens which has a concave/convex pattern in its outer surface and a microlens which has a refractive index distribution of a predetermined shape in a planer layer (sometimes called “planer microlens”), there are difficulty in controlling the shape of the lens, difficulty in precisely controlling the ratio between the thickness of a convex portion of the lens and the thickness of an adhesive layer, and/or difficulty in controlling the distribution of light beams with high accuracy. Especially in the case of a microlens which has a concave/convex pattern in its outer surface, uniform adhesion with high accuracy is difficult. Also, there is a problem that the lens characteristics vary depending on the size and shape of part of the microlens which is buried in the adhesive layer. Therefore, the microlens of this type has not been put to practice.

The present invention was conceived for the purpose of solving the above problems. One of the major objects of the invention is to improve the viewing angle characteristics of TN mode liquid crystal display devices.

### Means for Solving the Problems

A light diffusing sheet of the present invention includes at least one light diffusing layer which has a first major surface and a second major surface opposing each other and which is provided such that the first major surface opposes a viewer side surface of a TN mode liquid crystal display panel, wherein the light diffusing layer contains a first substance which has a first refractive index N1 and a second substance which has a second refractive index N2, the second refractive index N2 being smaller than the first refractive index N1, the second substance forms a plurality of second regions, a shape of each of the second regions in a cross section perpendicular to the second major surface being approximated to an isosceles triangle where a base is on the second major surface side and a vertex is on the first major surface side, the plurality of second regions being arranged in a first region formed of the first substance at a predetermined pitch P in at least one direction in a plane parallel to the second major surface, and formulae shown below are met:

$$H \leq \frac{P}{tan 2 α + tan α}$$

$$and$$

$$cos [ α ( 2 n - 1 ) ] > \frac{{N}_{2}}{{N}_{1}}$$

where H is a height of the isosceles triangle, 2α is a vertex angle, and n is an integer not less than 2.

A liquid crystal display device of the present invention includes: a TN mode liquid crystal display panel including a pair of polarizing plates; at least one light diffusing layer which has a first major surface and a second major surface opposing each other and which is provided such that the first major surface opposes a viewer side surface of the liquid crystal display panel, wherein the light diffusing layer contains a first substance which has a first refractive index N1 and a second substance which has a second refractive index N2, the second refractive index N2 being smaller than the first refractive index N1, the second substance forms a plurality of second regions, a shape of each of the second regions in a cross section perpendicular to the second major surface being approximated to an isosceles triangle where a base is on the second major surface side and a vertex is on the first major surface side, the plurality of second regions being arranged in a first region formed of the first substance at a predetermined pitch P in at least one direction in a plane parallel to the second major surface, and formulae shown below are met:

$$H \leq \frac{P}{tan 2 α + tan α}$$

$$and$$

$$cos [ α ( 2 n - 1 ) ] > \frac{{N}_{2}}{{N}_{1}}$$

where H is a height of the isosceles triangle, 2α is a vertex angle, and n is an integer not less than 2.

In one embodiment, the at least one direction includes a first direction which is generally perpendicular to a normal viewing direction of the liquid crystal display panel.

In one embodiment, the at least one direction includes a second direction which is generally perpendicular to the first direction.

In one embodiment, the at least one light diffusing layer includes two light diffusing layers, the plurality of second regions in each of the two light diffusing layers are arranged in a stripe pattern along a sole direction in a plane parallel to the second major surface, the sole direction in one of the light diffusing layers is the first direction, and the sole direction in the other light diffusing layer is the second direction.

In one embodiment, the at least one light diffusing layer is a sole light diffusing layer, and the plurality of second regions are arranged in a grating pattern when viewed in a direction perpendicular to the second major surface.

In one embodiment, the at least one light diffusing layer is a sole light diffusing layer, and the plurality of first regions each have a generally circular shape and are arranged in a square grating arrangement or a closest packed arrangement when viewed in a direction perpendicular to the second major surface.

In one embodiment, the second regions further include a substance which absorbs visible light. The substance which absorbs light may preferably be, for example, carbon black or a mixture of a blue pigment and a red pigment. The visible light absorbance is preferably 95% or more.

In one embodiment, the predetermined pitch P is preferably not more than three quarters of a pixel pitch in the direction. More preferably, two or more of the low refractive index regions are placed within the extent of the opening of a pixel.

In one embodiment, the arrangement direction of the plurality of second regions is preferably inclined by 1° or more relative to a bus line of the liquid crystal display panel.

In one embodiment, the liquid crystal display device may further include, on a viewer side of the light diffusing layer, at least one selected from the group consisting of an antiglare layer, an antireflection layer, a low reflection layer, and a reflection preventing layer.

In one embodiment, the liquid crystal display panel preferably further includes an optical compensation film. Preferably, the optical compensation film may be, for example, a film manufactured by FUJITILM Corporation with the trade name of “WV film”.

In one embodiment, the liquid crystal display device further includes a backlight unit. The directivity of light emitted from the backlight unit (which is represented by the half-value angle Δθ₅₀; the half-value angle Δθ₅₀ means angles (polar angles) +Δθ₅₀ and −Δθ₅₀ at which the intensity is a half of the maximum where the maximum in the light intensity distribution is assumed to occur at the angle of 0°) is preferably within the range of ±35° or less and is preferably more than ±10°.

### EFFECTS OF THE INVENTION

A light diffusing layer included in a light diffusing sheet and a liquid crystal display device of the present invention includes a plurality of low refractive index regions (second regions) formed of a substance which has a low refractive index (second substance). The shape of each of the low refractive index regions in a cross section perpendicular to the major surface is approximated to an isosceles triangle where the base is on the viewer side and the vertex is on the liquid crystal display panel side. The plurality of low refractive index regions are arranged in a high refractive index region (first region) formed of a high refractive index substance (first substance) at a predetermined pitch P in at least one direction in a plane parallel to the major surface. Light which comes from the high refractive index region side and which is incident on an interface between the high refractive index region and the low refractive index region at an angle not smaller than a critical angle is totally reflected. The shape and size of the low refractive index regions satisfy a predetermined relationship expressed by the two formulae shown above. Therefore, light which is perpendicularly incident on the major surface (the absolute value of the angle of incidence is not less than 0° and less than 0.1°) undergoes total reflection only once inside the light diffusing layer before outgoing from the light diffusing layer toward the viewer side, and part of the light which is incident on the major surface at an oblique angle (the absolute value of the angle of incidence is 0.1° or more) undergoes total reflection n or more times (n is an integer not less than 2) inside the light diffusing layer before outgoing from the light diffusing layer toward the viewer side. As a result, the viewing angle characteristic in the at least one direction (the polar angle (θ) dependence in an azimuthal angle determined by the at least one direction) is improved.

The light diffusing layer utilizes total reflection and is therefore less affected by the shape as compared with a case where a refraction effect of a lens is utilized. Further, the low refractive index regions have a simple shape which is approximated to an isosceles triangle and are therefore advantageous in terms of easiness of manufacture. Further, the major surfaces (surfaces) of the light diffusing layer which oppose each other are parallel to each other and can be readily bonded onto the surface of the liquid crystal display panel. The surface which is to be bonded onto the liquid crystal display panel is formed only by the high refractive index region. Therefore, the total reflection characteristics inside the light diffusing layer are not affected at all by the bonding.

### BRIEF DESCRIPTION OF DRAWINGS

FIG. 1 A schematic exploded cross-sectional view of a liquid crystal display device 100 of an embodiment of the present invention.

FIG. 2 A schematic exploded perspective view of the liquid crystal display device 100 of the embodiment of the present invention.

FIG. 3 A schematic perspective view of another liquid crystal display device 110 of an embodiment of the present invention.

FIG. 4 A diagram for illustrating the structure and functions of a light diffusing layer 10.

FIGS. 5 (a) and (b) are graphs showing the diffusion characteristics of light outgoing from different light diffusing layers. (a) corresponds to a case where the half-value angle Δθ₅₀ of light emitted from the backlight unit is ±10°. (b) corresponds to a case where the half-value angle Δθ₅₀ of light emitted from the backlight unit is ±35°.

FIG. 6 (a) to (c) are graphs showing the viewing angle dependence of the γ characteristic of a conventional TN mode liquid crystal display device.

FIG. 7 (a) to (c) are graphs showing the viewing angle dependence of the γ characteristic of a TN mode liquid crystal display device of an embodiment of the present invention.

FIGS. 8 (a) and (b) are graphs showing the color difference in a conventional liquid crystal display device.

FIGS. 9 (a) and (b) are graphs showing the color difference in a liquid crystal display device of an embodiment of the present invention.

FIGS. 10 (a) and (b) are diagrams for illustrating overlapping images which can be visually perceived when a light diffusing layer of an embodiment of the present invention is used. (a) is a schematic cross-sectional view. (b) is a schematic plan view.

FIGS. 11 (a) and (b) are diagrams showing other light diffusing layers of the present invention. (a) is a perspective view of another light diffusing layer. (b) is a front view of still another light diffusing layer.

### DESCRIPTION OF THE REFERENCE NUMERALS

10 light diffusing sheet, light diffusing layer (total reflection diffusing layer)
12, 12a, 12b high refractive index region (first region)
12s interface (total reflection surface)
14 low refractive index region (second region)
20 TN mode liquid crystal display panel
20a glass substrate on viewer side
30 backlight unit
100 liquid crystal display device
302a perpendicular incident light
302b light outgoing after having been totally reflected only once (perpendicular incident light)
304a, 306a oblique incident light
304b light outgoing after having been totally reflected twice (part of oblique incident light)
306b light outgoing after having been totally reflected only once (part of oblique incident light)

### BEST MODE FOR CARRYING OUT THE INVENTION

Hereinafter, a light diffusing sheet and a liquid crystal display device which includes the light diffusing sheet according to an embodiment of the present invention are described as to the structures and properties with reference to the drawings. The liquid crystal display device of the present invention may be a direct-viewing type liquid crystal display device wherein light outgoing from a display surface is directly viewed by a viewer.

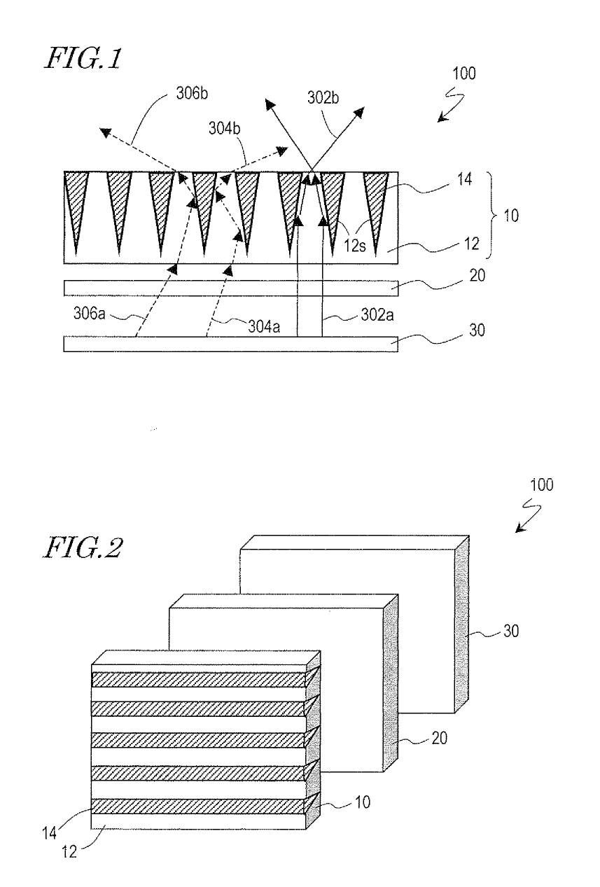

A light diffusing sheet 10 and a liquid crystal display device 100 which includes the light diffusing sheet 10 according to an embodiment of the present invention are described as to the structures and properties with reference to FIG. 1 and FIG. 2. FIG. 1 is a schematic exploded cross-sectional view of the liquid crystal display device 100. FIG. 2 is a schematic exploded perspective view of the liquid crystal display device 100.

The liquid crystal display device 100 includes the light diffusing sheet 10, a TN mode liquid crystal display panel 20, and a backlight unit 30.

The light diffusing sheet 10 includes one light diffusing layer 10 which has a first major surface and a second major surface opposing each other and which is provided such that the first major surface opposes the viewer side surface of the TN mode liquid crystal display panel. In the example described herein, the light diffusing sheet 10 is formed by only one light diffusing layer 10. Alternatively, a base film (not shown) may be provided on a side of the light diffusing layer 10 which is closer to the liquid crystal display panel 20 (light incoming side). The viewer side (light outgoing side) of the light diffusing layer 10 may be provided with an antiglare layer, an antireflection layer, a low reflection layer, or a reflection preventing layer (although none of these is shown). As a matter of course, any two or more of these layers may be used in combination when necessary. The light diffusing sheet 10 and the liquid crystal display panel 20 are bonded together via an adhesive layer (not shown). The both outermost surfaces of the liquid crystal display panel 20 are generally provided with polarizing plates, and therefore, the light diffusing sheet 10 is bonded to the polarizing plate on the viewer side. Here, a structure obtained by bonding the light diffusing sheet 10 to the liquid crystal display panel 20 (which does not include the backlight unit 30) is sometimes referred to as a liquid crystal display device.

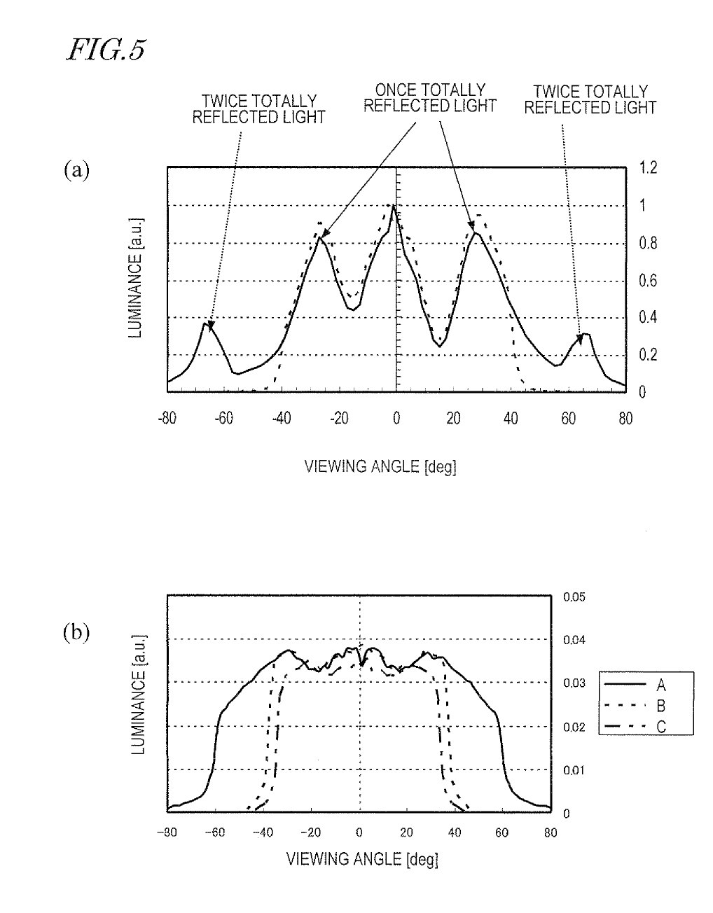

The light diffusing layer 10 includes the first substance having first refractive index N1 and the second substance having second refractive index N2. Second refractive index N2 is smaller than first refractive index N1. The second substance forms a plurality of second regions (low refractive index regions) 14. The shape of each of the second regions 14 in a cross section perpendicular to the second major surface is approximated to an isosceles triangle where the base is on the second major surface side and the vertex is on the first major surface side. The plurality of second regions 14 are arranged in a first region (high refractive index region) 12 formed of the first substance at predetermined pitch P in at least one direction in a plane parallel to the second major surface. Light which comes from the high refractive index region side and is incident on interfaces 12s between the high refractive index region 12 and the low refractive index regions 14 at an angle not smaller than a critical angle is totally reflected. Since the isosceles triangle meets predetermined conditions as will be described later with reference to FIG. 4, light 302a which is incident perpendicularly onto the major surface of the light diffusing layer 10 (the absolute value of the angle of incidence is not less than 0° and less than 0.1°) undergoes total reflection only once inside the light diffusing layer 10 before outgoing from the light diffusing layer 10 toward the viewer side (outgoing light 302b). Part of light which is incident on the major surface at an oblique angle (the absolute value of the angle of incidence is 0.1° or greater), 304a, undergoes total reflection n or more times (n is an integer not less than 2, n=2 in FIG. 1) inside the light diffusing layer 10 before outgoing from the light diffusing layer toward the viewer side (outgoing light 304b). Another part of the light which is incident on the major surface at an oblique angle (the absolute value of the angle of incidence is 0.1° or greater), 306a, undergoes total reflection only once inside the light diffusing layer 10 before outgoing from the light diffusing layer 10 toward the viewer side (outgoing light 306b). In this way, the light diffusing layer 10 diffuses light by utilizing total reflection and is therefore sometimes referred to as “total reflection diffusing layer”.

Here, as shown in FIG. 2, when viewed in a direction perpendicular to the major surfaces of the light diffusing layer 10, each of the plurality of second regions 14 has the shape of a horizontally-extending rectangle. The plurality of second regions 14 are arranged along a perpendicular direction. As seen from the correspondence of FIG. 1 to the vertical cross-sectional view of FIG. 2, the light diffusing layer 10 is capable of improving the viewing angle characteristics in the vertical directions (i.e., the polar angle (θ) dependence in the vertical directions). In many of the TN type liquid crystal display panels 20 although it depends on the purpose of use, when describing with an imaginary clock dial superposed on the display surface, the normal viewing direction is set to 6 o'clock direction. Here, the “normal viewing direction” refers to the pretilt direction of the liquid crystal molecules in the thickness direction of the liquid crystal layer. The polarization axes (transmission axes) of a pair of polarizing plates placed in a crossed Nicols arrangement form angles of about 45° relative to the vertical directions (12 o'clock and 6 o'clock directions) and the horizontal directions (3 o'clock and 9 o'clock directions) of the display surface. In such TN type liquid crystal display devices, as will be described later in connection with examples of the polar angle dependence of the γ characteristics (the polar angle is an angle deviated from the normal of the display surface), the polar angle dependence of the γ characteristics in the vertical directions are especially poor (whitening and an inversion phenomenon occur). Therefore, using the light diffusing layer 10 that includes a plurality of rectangular second regions 14 which are extending in the horizontal directions and which are arranged along the vertical directions is advantageous.

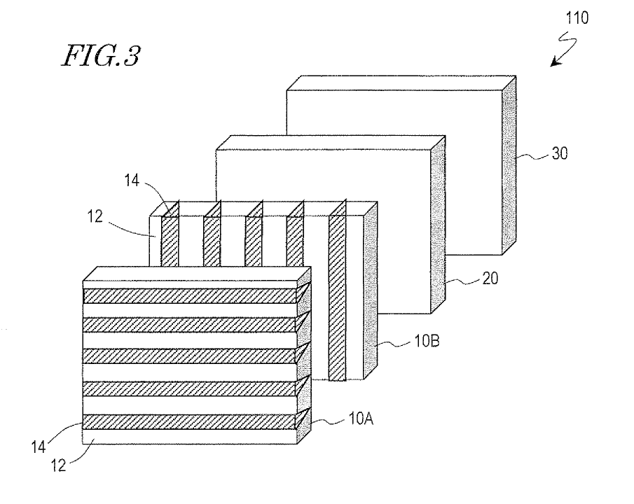

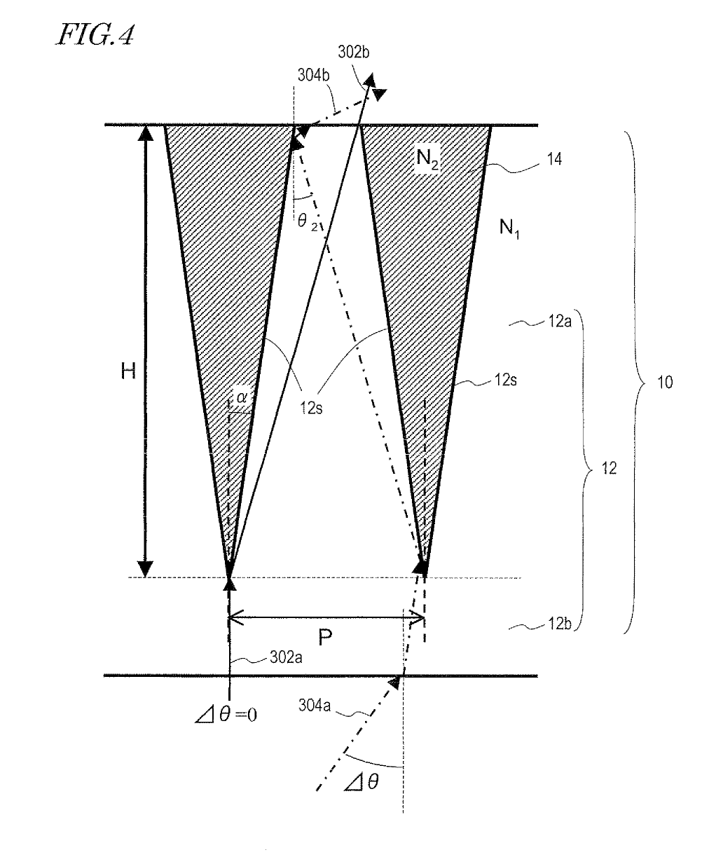

Alternatively, as in a liquid crystal display device 110 whose schematic perspective view is shown in FIG. 3, light diffusing layers 10A and 10B may be provided. Here, the light diffusing layer 10A is the same as the light diffusing layer 10 of the liquid crystal display device 100. The light diffusing layer 10B includes a plurality of vertically-extending rectangular second regions 14 which are arranged along a horizontal direction. By additionally providing the light diffusing layer 10B in this way, the viewing angle characteristics in the horizontal directions can be improved.

Next, the structure and functions of the light diffusing layer 10 are described in detail with reference to FIG. 4. In the following description, for the sake of simplicity, the major surfaces of the liquid crystal display panel 20 and the major surfaces of the light diffusing layer 10 are parallel. Refraction of light which would occur at the interface between these elements and at the interfaces with an adhesive layer (not shown) for bonding these elements is ignored. Note that the description below generally holds true even when such refraction is considered.

Here, as shown in FIG. 4, the pitch of the low refractive index regions 14 is denoted by 2, the height of the isosceles triangle is denoted by H, and the vertex angle of the isosceles triangle is denoted by 2α. Light 302a which is incident perpendicularly onto the light diffusing layer 10 (Δθ=0 in FIG. 4) undergoes total reflection only once. Therefore, when considering the most strict design conditions, the condition that light totally reflected at the vertex of a low refractive index region 14 outgo from the surface of the light diffusing layer 10 without entering a neighboring low refractive index region 14 (outgoing light 302b) is necessary. Thus, the following formula holds:

$$H \leq \frac{P}{tan 2 α + tan α} \qquad ( 1 )$$

Also, the condition that light incident on the light diffusing layer 10 in an oblique direction (|Δθ|>0°) undergo total reflection once, which is shown below, need to be met (see the incident light 306a and the outgoing light 306b in FIG. 1):

$${N}_{1} cos \{ {sin}^{- 1} ( \frac{sin Δθ}{{N}_{1}} ) + α \} > {N}_{2} \qquad ( 2 )$$

In order that part of the light incident on the light diffusing layer 10 in an oblique direction (|Δθ|>0°), 304a, may undergo total reflection twice before outgoing from the light diffusing layer 10 (outgoing light 304b), θ₂ need to meet the condition that total reflection occur at the interfaces 12s.

θ₂ is given as follows:

$${θ}_{2} = {sin}^{- 1} ( \frac{sin Δθ}{{N}_{1}} ) + 2 α \qquad ( 3 )$$

Therefore, due to the Snell's law, the total reflection condition at the interfaces 12s between the high refractive index region (first region: N1) 12 and the low refractive index regions (second regions: N2) 14 is as follows:

N₁ sin(90°−θ₂−α)=cos(θ₂+α)>N₂ (4)

This formula is transformed by replacing θ₂ as follows:

$${N}_{1} cos ( {sin}^{- 1} ( \frac{sin Δθ}{{N}_{1}} ) + 3 α ) > {N}_{2} \qquad ( 5 )$$

Actually, in formula (5), the light which undergoes total reflection twice is not collimated light (Δθ=0° does not hold) but light that is incident at an angle in a region of Δθ which is extremely close to collimated light. Therefore, the following relationship can be deduced:

$${lim}_{Δθ \to 0} {N}_{1} cos ( {sin}^{- 1} ( \frac{sin Δθ}{{N}_{1}} ) + 3 α ) = {N}_{1} cos ( 3 α ) > {N}_{2} \\ ∴ cos ( 3 α ) > \frac{{N}_{2}}{{N}_{1}} \qquad ( 6 )$$

As such, to design the light diffusing layer (total reflection diffusing layer) 10 such that light perpendicularly coming in the liquid crystal display panel (Δθ=0) undergoes total reflection only once and part of the light coming in the liquid crystal display panel in an oblique direction (|Δθ|>0) undergoes total reflection twice under the circumstance where the backlight unit used has the half-value angle Δθ₅₀ in the case of a certain directivity, the light diffusing layer may be designed so as to meet above formulae (1) and (6). By doing so, not only the once-totally-reflected light of the oblique light but also the twice-totally-reflected light can efficiently be utilized, so that wide viewing angle characteristics are achieved.

In a case where part of the oblique incident light is allowed to undergo total reflection n or more times (n≦12), above formula (6) can be expanded to the following formula:

$$cos [ α ( 2 n - 1 ) ] > \frac{{N}_{2}}{{N}_{1}} ( n is an integer not less than 2 ) \qquad ( 7 )$$

Therefore, in a case where part of the oblique incident light is allowed to undergo total reflection n or more times, the light diffusing layer is designed so as to meet formulae (1) and (7).

Also, as a matter of course, it is necessary to meet the condition that light should not finally undergo total reflection but be refracted at the interface between the high refractive index region 12 (refractive index N₁) and the air so as to outgo from the high refractive index region 12. Therefore, as for light which undergoes total reflection n times at the interfaces 12s between the high refractive index region 12 and the low refractive index regions 14, it is necessary to meet the following formula:

$${N}_{1} sin \{ {sin}^{- 1} ( \frac{sin Δθ}{{N}_{1}} ) + 2 n α \} < 1 \\ ( total reflection n times , n is an integer not less than 1 ) \qquad ( 8 )$$

Under the circumstance where formula (1) and formula (6) or formula (1) and formula (7) are met, the maximum intensity in the intensity distribution of light emitted from the backlight unit 30 is assumed to be 100%, and the angles at which the intensity is 10% are denoted by ±Δθ₁₀. Designing the light diffusing layer such that ±Δθ₁₀ meets formula (1) and formula (6) or formula (1) and formula (7) is preferable because light transmitted through and outgoing from the liquid crystal display panel 20 can be utilized efficiently (90% or more) in the light diffusing layer 10. In this case, the means for condensing the light emitted from the backlight unit 30 may be selected from a wide variety of known optical elements. For example, a prism sheet, an integral structure of a prism sheet and a diffuse reflection plate (light scattering plate), a lover, or a reversed prism may be used. Note that, in the present specification, when such an element is added, a unit including the added element is referred to as “backlight unit”.

Note that the directivity of the light emitted from the backlight unit does not necessarily need to be set such that the above-described conditions are met. The viewing angle characteristics are not affected so long as light incident at an angle which does not meet the above-described conditions is absorbed by the low refractive index regions 14 as will be described later.

Next, the difference in light diffusion characteristic among the cases where light diffusing layers characterized by the following three parameter sets A, B, and C (respectively referred to as “light diffusing layers A, B, and C”) are used is described with reference to FIG. 5. The light diffusing layer A meets the above-described conditions (Example) whereas the light diffusing layers B and C do not meet the above-described conditions (Comparative Examples).

A: N₁=1.55, N₂=1.40, α=8.0°, P=50 μm, H=110 μm

B: N₁=1.55, N₂=1.50, α=8.0°, P=50 μm, H=110 μm

C: N₁=1.55, N₂=1.50, α=6.0°, P=50 μm, H=155 μm

FIG. 5(a) shows the diffusion characteristic of light outgoing from the light diffusing layer 10 under the circumstance where light having the directivity of half-value angle Δθ₅₀=±10° comes from the backlight unit and enters the light diffusing layers A and B. The diffusion characteristic shown herein is the polar angle dependence of the outgoing light intensity in a direction in which the low refractive index regions 14 are arranged a a predetermined pitch, and corresponds to the viewing angle characteristics of the liquid crystal display device. It is seen that the light diffusing layer A can efficiently utilize the light which has undergone total reflection twice inside the light diffusing layer and, as a result, the intensity distribution of the outgoing light extends over a wide angle range as compared with the light diffusing layer B.

However, the intensity distribution of the outgoing light of the light diffusing layer A of FIG. 5(a) shows prominent peaks of the once-totally-reflected light and prominent peaks of the twice-totally-reflected light. These peaks may cause the viewer to feel a sense of discontinuity in the viewing angle characteristics. Thus, to prevent this, decreasing the directivity of light which comes in the light diffusing layer, i.e., increasing the half-value angle Δθ₅₀, is preferable. FIG. 5(b) shows a result of the diffusion characteristics under the circumstance where the half-value angle Δθ₅₀ of the light emitted from the backlight unit is +35′. As seen from FIG. 5(b), the intensity distribution of the outgoing light of the light diffusing layer A which meets the above-described conditions is wider than those of the light diffusing layers B and C, and does not have a prominent peak such as those seen in FIG. 5(a). Thus, it is possible to prevent the viewer from feeling a sense of discontinuity in the viewing angle characteristics.

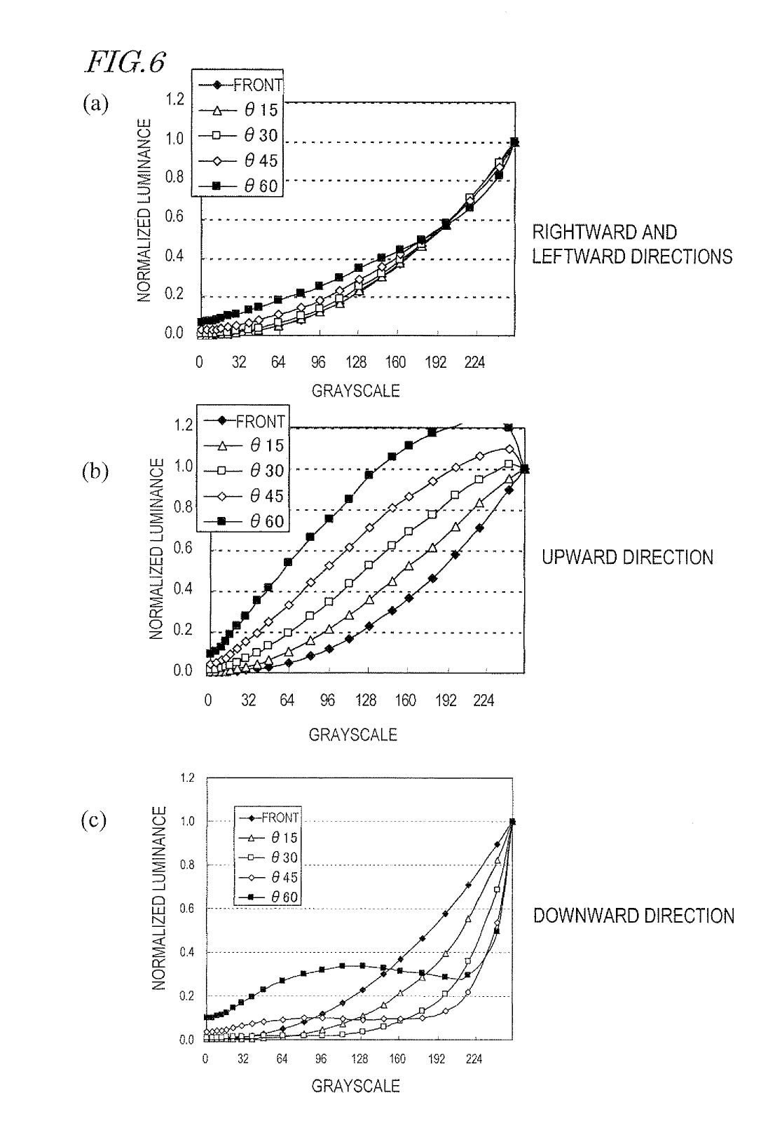

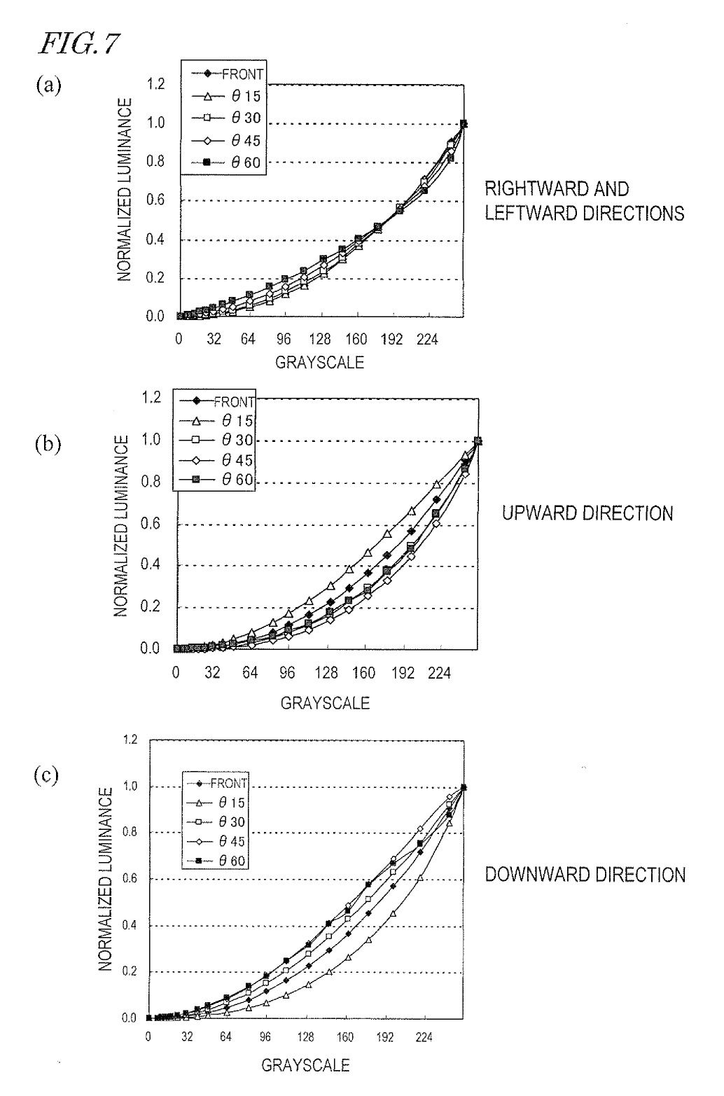

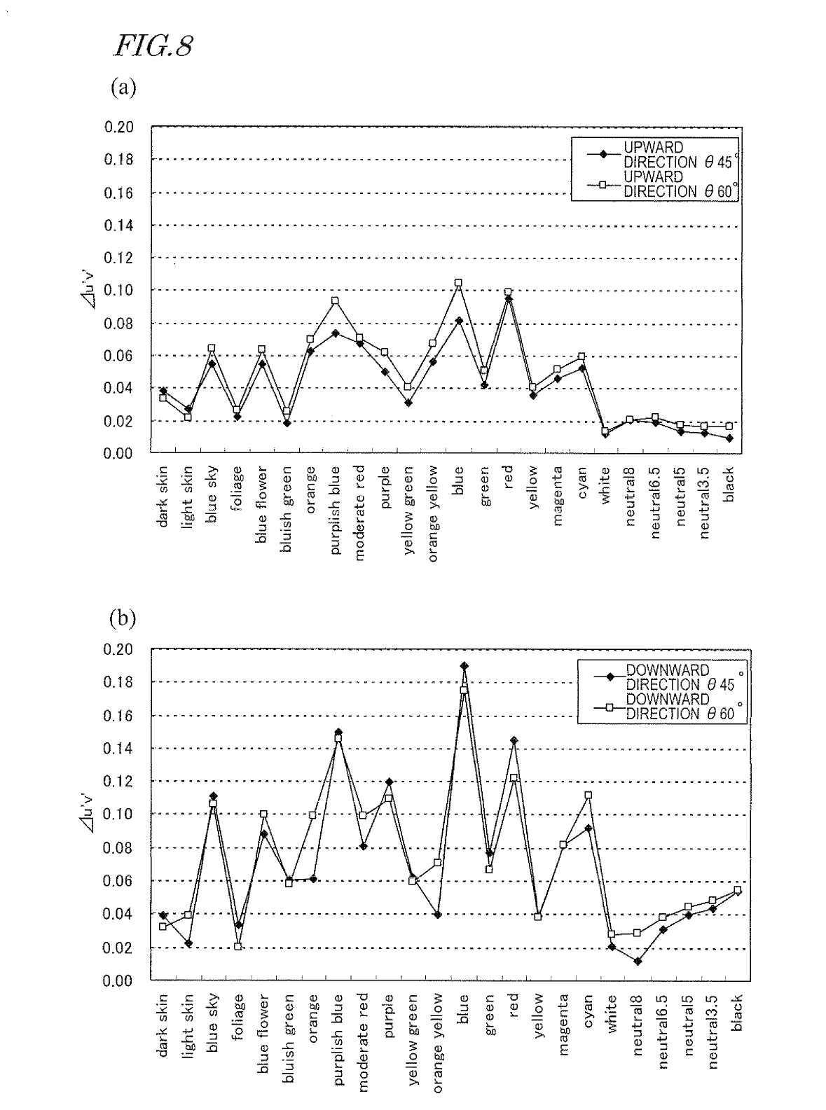

Next, the viewing angle dependence (polar angle dependence) of theγ characteristic of a conventional TN mode liquid crystal display device and a TN mode liquid crystal display device of an embodiment of the present invention is described with reference to FIG. 6 and FIG. 7. In the graphs of FIG. 6 and FIG. 7, the abscissa axis represents the grayscale levels which are intended to be displayed (input grayscale levels). The ordinate axis represents the normalized luminance relative to the displayed luminance in the front direction at the highest input grayscale level (level 255) which is expressed as 1. Any of these liquid crystal display devices is configured such that the curve of γ=2.2 is obtained when viewed from a position in front of the display device.

FIGS. 6(a) to 6(c) are graphs showing the viewing angle dependence of the γ characteristic of the conventional TN mode liquid crystal display device. This conventional liquid crystal display device includes a phase plate (a WV film manufactured by FUJIFILM Corporation). FIGS. 7(a) to 7(c) are graphs showing the viewing angle dependence of the γ characteristic of the TN mode liquid crystal display device of an embodiment of the present invention, which includes a light diffusing layer 10 that meets the above-described conditions in addition to the components of the conventional TN type liquid crystal display device that has the viewing angle characteristics of FIGS. 6(a) to 6(c). This liquid crystal display device has the same structure as that of the liquid crystal display device 100 shown in FIG. 1 and FIG. 2.

As seen from FIG. 6(a), the polar angle (θ) dependence in the rightward and leftward directions (horizontal directions) of the conventional liquid crystal display device is close to the curve of γ=2.2. This is because of optical compensation by the phase plate (WV film). However, the graph of the polar angle dependence in the upward direction (12 o'clock direction) illustrated in FIG. 6(b) shows that whitening (a phenomenon that the state of display is at a higher luminance than that originally intended) is conspicuous. Specifically, whitening occurs when the liquid crystal display panel is viewed from an upward position, whereas the grayscale curve is γ=2.2 when viewed from a position in front of the panel (polar angle=0°). In a range near the highest grayscale level, grayscale inversion (a phenomenon that the luminance decreases as the grayscale level increases) occurs. Further, as seen from FIG. 6(c), when the liquid crystal display panel is viewed from a downward position (6 o'clock position), both whitening and grayscale inversion occur at intermediate grayscale levels.

On the other hand, referring to FIGS. 7(a) to 7(c), it is seen that, in the liquid crystal display device of the embodiment of the present invention, the viewing angle characteristics in the upward direction and the downward direction that are perpendicular to the direction in which the low refractive index regions 14 of the light diffusing layer 10 are extending are significantly improved. In the example described herein, the above parameters of the light diffusing layer are N₁=1.59, N₂=1.40, α=8.0°, P=50 μm, and H=110 μm. Specifically, in the embodiment of the present invention, in any of the upward direction and the downward direction, grayscale inversion does not occur, and whitening is extremely ameliorated. Also, the grayscale characteristics in diagonal directions (polar angle>0°) reach a value which is close to γ=2.2.

Note that the half-value angle Δθ₅₀ of the light emitted from the backlight unit used herein is about ±35°, and this light includes rays which deteriorate the viewing angle characteristics. Therefore, by limiting the half-value angle Δθ₃₀ to ±30° or less, more preferably by limiting Δθ₅₀ to ±15° or less, the grayscale characteristic in an oblique viewing angle (|θ|>0°) can reach a value which is closer to γ=2.2. Note that, as will be described later, when employing a structure where light incident on the light diffusing layer at a large angle of incidence is absorbed by the low refractive index regions 14, the directivity of light emitted from the backlight unit does not necessarily need to be increased, i.e., the half-value angle does not necessarily need to be decreased.

Although in the example described herein the phase plate for improving the viewing angle characteristics of the TN mode liquid crystal display device (see, for example, Japanese Laid-Open Patent Publication No. H6-75116) is a WV film manufactured by FUJIFILM Corporation, the viewing angle characteristics can be improved by the light diffusing layer 10 even when the phase plate is omitted. In this case, the light diffusing layers 10A and 10B are preferably provided such that the low refractive index regions 14 are arranged in stripe patterns in the horizontal direction and the vertical direction as in the liquid crystal display device 110 shown in FIG. 3. Alternatively, other light diffusing layers which will be described later with reference to FIG. 11 may be used.

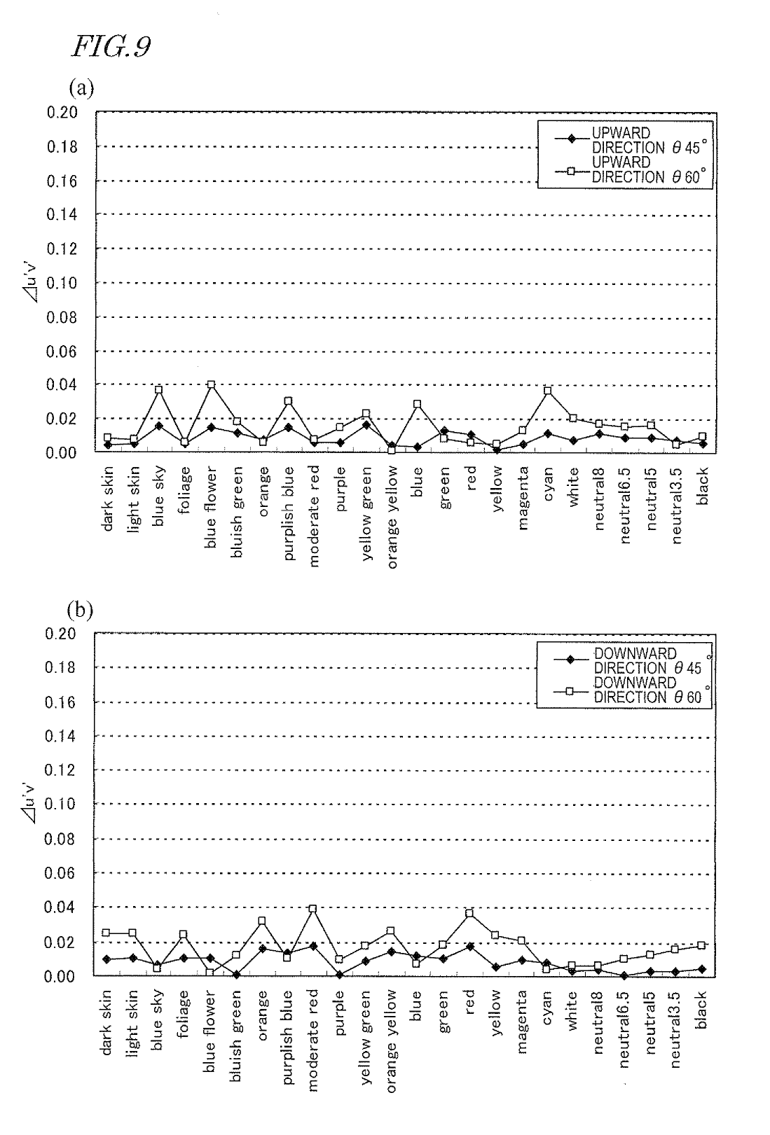

Next, the chromaticity change characteristic is described with reference to FIGS. 8(a) and 8(b) and FIGS. 9(a) and 9(b). FIGS. 8(a) and 8(b) show the color difference in a conventional liquid crystal display device. FIGS. 9(a) and 9(b) show the color difference in a liquid crystal display device of an embodiment of the present invention. The conventional liquid crystal display device has the viewing angle dependence of the γ characteristic which is shown in FIG. 6. The liquid crystal display device of this embodiment has the viewing angle dependence of the γ characteristic which is shown in FIG. 7. FIG. 8 and FIG. 9 each represent the chromaticity obtained when the display device is viewed from (a) an upward position (12 o'clock position) and (b) a downward position (6 o'clock position), showing the results obtained when the polar angle θ is 45° and 60°. FIG. 8 and FIG. 9 show the change in chromaticity (difference from the chromaticity at θ=0°) in the Macbeth chart which occurs depending on the viewing angle. The colors up to the 18th (cyan) from the left are chromatic colors, and the colors from the 19th (white) to the 24th (black) are achromatic colors.

As shown in FIGS. 8(a) and 8(b), in the conventional liquid crystal display device, as for the chromaticity change in the respective colors at the polar angle θ=45°, some colors have large color differences Δu′v′ in the u′v′ chromaticity coordinates. On the other hand, as shown in FIGS. 9(a) and 9(b), in the liquid crystal display device of the embodiment of the present invention, the color differences Δu′v′ are small values which are not more than 0.02.

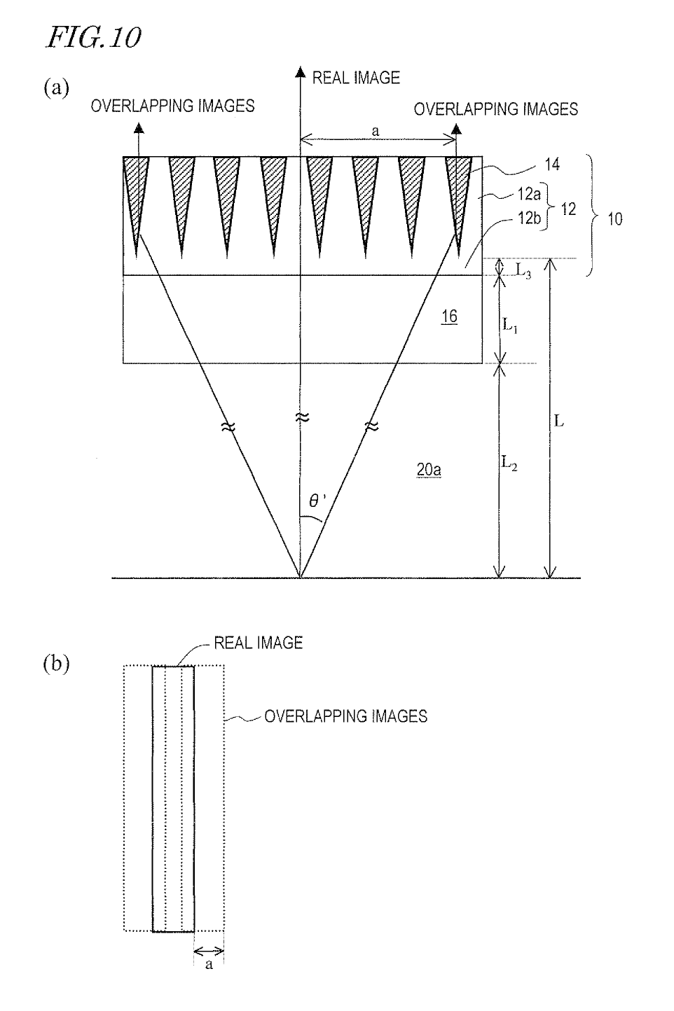

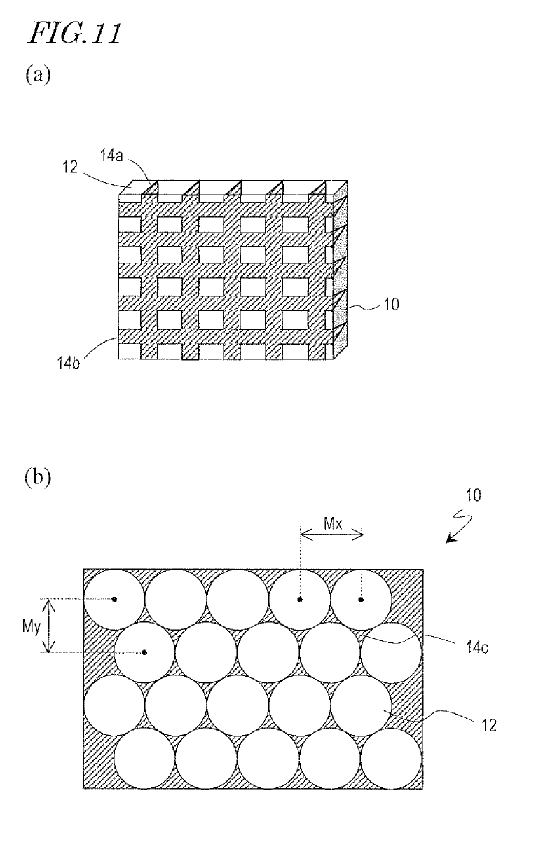

Next, overlapping images which can be visually perceived when a light diffusing layer of an embodiment of the present invention is used are described with reference to FIGS. 10(a) and 10(b).

As schematically shown in FIG. 10(a), the light emitted from the backlight unit includes rays which meet |θ′|>0° and which are emitted at angles that do not meet the above-described conditions. Therefore, a real image (primary image) produced by light of θ′=0° and overlapping images (secondary images) produced by light incident at angles of |θ′|>0° may be visually perceived. This is because the light incident on the light diffusing layer 10 at an angle of |θ′|>0° outgoes frontward at a position distant by distance a (μm) from a position where the light incident at θ′=0° outgoes from the high refractive index region 12a of the light diffusing layer 10. The light incident on the light diffusing layer 10 at an angle of |θ′|>0° travels from the high refractive index region 12 into the low refractive index region 14 and is refracted there so as to outgo frontward. When a line for one pixel of the liquid crystal display device is lighted, a viewer viewing the liquid crystal display device in a direction perpendicular to the display surface would visually perceive a real image and overlapping images as shown in FIG. 10(b).

θ′ shown herein is an angle which represents the traveling direction of light inside a glass substrate 20a provided on the viewer side of the liquid crystal display panel 20 (the polarizing plate is ignored because it is thin). The light is refracted when entering a base film 16 and is again refracted when entering the high refractive index region 12 so as to travel with an angle smaller than θ′, although the difference in refractive index between these elements is small. Since the decrease in the angle of incidence due to the refraction is not considered, the conditions obtained herein are to be stricter than the actual conditions.

The above-described overlapping images result from the fact that part of the light traveling from the high refractive index region 12 into the low refractive index regions 14 (the light incident at a smaller angle than the critical angle) is not totally reflected by the interfaces 12s but is refracted to enter the low refractive index regions 14, and the refracted light outgoes in a direction perpendicular to the display surface. Thus, the countermeasures which will be described below are capable of effectively removing the overlapping images.

(Countermeasure 1)

Occurrence of overlapping images can be effectively prevented by mixing a material which has the property of absorbing visible light in the low refractive index regions 14 in order to absorb light which comes in the low refractive index regions 14. The material which absorbs visible light may preferably be, for example, carbon black or a mixture of a blue pigment and a red pigment. The visible light absorbance is preferably 95% or more, and more preferably 99% or more.

(Countermeasure 2)

To prevent light which comes in the low refractive index regions 14 from outgoing in a direction perpendicular to the display surface, refraction of the light at the low refractive index regions 14 is prevented. This may be accomplished so long as the following condition, which is transformed from formula (2) on the assumption that total reflection occurs n times, is met.

$${N}_{1} cos \{ {sin}^{- 1} ( \frac{sin Δθ}{{N}_{1}} ) + n α \} > {N}_{2} \\ ( n is an integer not less than 1 )$$

For example, when N₁=1.55, N₂=1.40, α=8.0°, and n=1, Δθ is about 27°. Therefore, by limiting all the light beams emitted from the backlight unit to 27° or less, overlapping images can be extremely decreased. When light of n=2 is further considered, overlapping images cannot be visually perceived in principle by limiting all the light beams from the backlight unit to 15° or less.

(Countermeasure 3)

Occurrence of overlapping images may be allowed so long as they are not perceived by a human eye. For example, a viewer who has the visual acuity of 1.0 based on the Landolt ring, 50 cm away from the liquid crystal display panel, can discern the distance of 150 μm. Thus, a may be set to 150 μm or less. Now consider a case where common values are used for example, the glass thickness is 700 μm, the thickness of the polarizing plate is 200 μm, and the thickness of the base film is 200 μm. In the case of Countermeasure 2, when condensation of light from the backlight is insufficient, visual perception of overlapping images can be prevented by decreasing the glass thickness, the polarizing plate thickness, and the base film thickness. Thus, the condition of tan θ′*L<150 μm may be met. Therefore, in this case, Δθ=sin⁻¹(N₁ sin θ′) holds. Hence, the half-value angle Δθ₅₀ or Δθ₁₀ of the backlight unit may be set to sin⁻¹(N₁ sin θ′). In some uses, the distance between the viewer and the panel may be less than 50 cm, and in such a case, the discernible distance is decreased.

If the condition of Countermeasure 2 cannot be met, the thickness of the glass substrate (including the thickness of the polarizing plate), L₂, the thickness of the base film 16, L₁, and the thickness of the layer 12b which is formed only by the high refractive index region, L₃, which are shown in FIG. 10(a), may be decreased to adjust L such that the above-described condition is met.

To solve the above-described problem of overlapping images, increasing the directivity of the backlight (decreasing the half-value angle) may be preferable However, if the directivity of the backlight is excessively increased, the peaks of once-totally-reflected light and twice-totally-reflected light are conspicuous as shown in FIG. 5(a), resulting in a sense of discontinuity in the viewing angle characteristics. Thus, Countermeasures 1 and 3 are preferable because they can simultaneously prevent the problem illustrated in FIG. 5(a) and occurrence of overlapping images.

The light diffusing layer of the embodiment of the present invention is not limited to the above-described examples but may be, for example, those illustrated in FIGS. 11(a) and 11(b).

The light diffusing layer 10 shown in FIG. 11(a) includes low refractive index regions 14a and 14b which extend perpendicular to each other to form a square grating. The light diffusing layers 10A and 10B of FIG. 3 are realized by a single light diffusing layer.

The light diffusing layer 10 shown in FIG. 11(b) includes generally-circular high refractive index regions 12 which are in a closest packed arrangement when viewed in a direction perpendicular to the major surfaces. The gaps between the high refractive index regions 12 are provided with a low refractive index region 14c. The shape of the low refractive index region 14c in a cross section perpendicular to the sheet of the drawing is an isosceles triangle (the bottom is on the anterior side of the sheet, and the vertex is on the posterior side). The light diffusing layer 10 shown in FIG. 11(b) serves substantially the same function and produces substantially the same effect as those of the light diffusing layer of FIG. 11(a). In the arrangement of the high refractive index regions 12 in the light diffusing layer 10 of FIG. 11(b), the ratio of the interval in a row direction, Mx, to the interval in a column direction, My, satisfies the relationship of Mx:My=2:√3. The packing fraction of the high refractive index regions in the major surface (sheet surface) of the light diffusing layer 10 on the light outgoing side is the maximum.

The light diffusing layer of an embodiment of the present invention includes a plurality of low refractive index regions which are arranged at a predetermined pitch in at least one direction as described above. As well known, if periodic structures having slightly different pitches are stacked one on the other, moiré is generated. Therefore, if the pitch of the periodic structure formed by the low refractive index regions of the light diffusing layer and the pitch of the periodic structure of the pixels of the liquid crystal display panel are slightly different, moiré may be generated. To effectively prevent generation of moiré without degrading the display quality, the pitch of the periodic structure formed by the low refractive index regions is preferably not more than three quarters of the arrangement pitch of the pixels in the same direction, and two or more low refractive index regions are preferably placed within the extent of the opening of a pixel. The arrangement direction of the low refractive index regions preferably has an inclination of ±1° or more relative to a bus line of the liquid crystal display panel (a gate bus line, a source bus line, and/or a CS bus line).

The light diffusing layer of an embodiment of the present invention can be fabricated using materials and methods described in Patent Document 2. For example, the high refractive index region can be formed of a resin, such as epoxy acrylate, and the low refractive index regions can be formed of a resin, such as urethane acrylate. Here, the high refractive index region preferably has high transparency because light transmitted through the high refractive index region is used for display. The light diffusing layer may be fabricated by forming a high refractive index resin layer so as to have cavities of a predetermined shape (a cross-sectional shape generally similar to an isosceles triangle) in its surface and filling the cavities with a low refractive index resin. The entire disclosures of Patent Document 2 are incorporated by reference in this specification. Note that the technology described in Patent Document 2 relates to a light diffusing sheet which is suitable to a screen of a projector. In this document, utilization of oblique incident light, which is significant in designing of a light diffusing layer that is to be provided on the viewer side of a direct-viewing type liquid crystal display device, is not considered at all.

### INDUSTRIAL APPLICABILITY

The present invention is applicable to a wide variety of TN mode liquid crystal display devices.

1. A light diffusing sheet, comprising at least one light diffusing layer which has a first major surface and a second major surface opposing each other and which is provided such that the first major surface opposes a viewer side surface of a TN mode liquid crystal display panel, wherein
the light diffusing layer contains a first substance which has a first refractive index N1 and a second substance which has a second refractive index N2, the second refractive index N2 being smaller than the first refractive index N1,
the second substance forms a plurality of second regions, a shape of each of the second regions in a cross section perpendicular to the second major surface being approximated to an isosceles triangle where a base is on the second major surface side and a vertex is on the first major surface side, the plurality of second regions being arranged in a first region formed of the first substance at a predetermined pitch P in at least one direction in a plane parallel to the second major surface, and
formulae shown below are met:
$$H \leq \frac{P}{tan 2 α + tan α}$$
$$and$$
$$cos [ α ( 2 n - 1 ) ] > \frac{{N}_{2}}{{N}_{1}}$$
where H is a height of the isosceles triangle, 2α is a vertex angle, and n is an integer not less than 2.

2. A liquid crystal display device, comprising:
a TN mode liquid crystal display panel including a pair of polarizing plates;
at least one light diffusing layer which has a first major surface and a second major surface opposing each other and which is provided such that the first major surface opposes a viewer side surface of the liquid crystal display panel, wherein
the light diffusing layer contains a first substance which has a first refractive index N1 and a second substance which has a second refractive index N2, the second refractive index N2 being smaller than the first refractive index N1,
the second substance forms a plurality of second regions, a shape of each of the second regions in a cross section perpendicular to the second major surface being approximated to an isosceles triangle where a base is on the second major surface side and a vertex is on the first major surface side, the plurality of second regions being arranged in a first region formed of the first substance at a predetermined pitch P in at least one direction in a plane parallel to the second major surface, and
formulae shown below are met:
$$H \leq \frac{P}{tan 2 α + tan α}$$
$$and$$
$$cos [ α ( 2 n - 1 ) ] > \frac{{N}_{2}}{{N}_{1}}$$
where H is a height of the isosceles triangle, 2α is a vertex angle, and n is an integer not less than 2.

3. The liquid crystal display device of claim 2, wherein the at least one direction includes a first direction which is generally perpendicular to a normal viewing direction of the liquid crystal display panel.

4. The liquid crystal display device of claim 3, wherein the at least one direction includes a second direction which is generally perpendicular to the first direction.

5. The liquid crystal display device of claim 4, wherein
the at least one light diffusing layer includes two light diffusing layers,
the plurality of second regions in each of the two light diffusing layers are arranged in a stripe pattern along a sole direction in a plane parallel to the second major surface,
the sole direction in one of the light diffusing layers is the first direction, and
the sole direction in the other light diffusing layer is the second direction.

6. The liquid crystal display device of claim 4 wherein
the at least one light diffusing layer is a sole light diffusing layer, and
the plurality of second regions are arranged in a grating pattern when viewed in a direction perpendicular to the second major surface.

7. The liquid crystal display device of claim 4, wherein
the at least one light diffusing layer is a sole light diffusing layer, and
the plurality of first regions each have a generally circular shape and are arranged in a square grating arrangement or a closest packed arrangement when viewed in a direction perpendicular to the second major surface.

8. The liquid crystal display device of claim 2, wherein the second regions further include a substance which absorbs visible light.

9. The liquid crystal display device of claim 2, wherein the predetermined pitch P is not more than three quarters of a pixel pitch in the direction.
